(19) United States
(12) Patent Application Publication
(10) Pub. No.: US 2011/0277542 A1
(43) Pub. Date: Nov. 17, 2011

(54) METHOD AND CONTROL DEVICE FOR DETERMINING A CHARACTERISTIC VISCOSITY VARIABLE OF AN ENGINE OIL

(75) Inventor: Piergiacomo TRAVERSA, NUERNBERG (DE)

(73) Assignee: SCHAEFFLER TECHNOLOGIES GMBH & CO. KG, Herzogenaurach (DE)

(21) Appl. No.: 13/109,380

(22) Filed: May 17, 2011

(30) Foreign Application Priority Data
May 17, 2010 (DE) 10 2010 020 755.1

(51) Int. Cl. G01N 11/00

(52) U.S. Cl. 73/54.01

(57) ABSTRACT

A method for determining a characteristic viscosity variable of an engine oil in an internal combustion engine with hydraulic control of the gas exchange valves where a provision is made for an oxygen concentration, which is measured in an exhaust gas from the internal combustion engine, or a comparison variable, which is derived from the oxygen concentration, to be used as a measure of the characteristic viscosity variable, in particular the viscosity itself. This allows, particularly in the case of electrohydraulic actuation of the gas exchange valves, a statement to be made about the currently actual property of the engine oil used, without additional hardware components being required.

### CROSS-REFERENCE TO RELATED APPLICATION

This application claims the benefit of DE 10 2010 020 755.1 filed May 17, 2010, which is incorporated by reference herein.

### FIELD OF THE INVENTION

The invention relates to a method and to a control device for determining a characteristic viscosity variable of engine oil in an internal combustion engine with hydraulic control of the gas exchange valves.

### BACKGROUND OF THE INVENTION

In modern motor vehicles, the so-called gas exchange valves, that is to say the inlet and/or outlet valves for the motor vehicle engine, are nowadays controlled in a load-dependent manner for the purposes of minimizing pollutants and reducing consumption. Various systems are used in the process. All systems share the common feature that the closing and/or opening times of the gas exchange valves are changed in a load-dependent manner in relation to the crankshaft position (rotational angle). Hydraulic control systems in which a change in the closing and/or opening times of the gas exchange valve is induced with the aid of a hydraulic fluid, specifically the engine oil, are also used for this purpose.

EP 1 544 419 A1, for example, discloses a first hydraulic control system, specifically a hydraulic camshaft adjuster. In a system of this kind, the phase angle between the crankshaft and the camshaft of a motor vehicle engine is changed with the aid of the hydraulic fluid. This is achieved by variably filling pressure chambers of an adjusting apparatus. Control valves, which are in the form of solenoid valves in particular, are usually provided for actuating and filling and emptying the pressure chambers.

The article “Elektrohydraulische Ventilsteuerung mit dem “Multi Air”-Verfahren [Electrohydraulic valve control using the “MultiAir” method]” in the German automotive engineering journal MTZ, 12/2009, discloses an alternative hydraulic control system for actuating the gas exchange valves. In the case of this electrohydraulic valve control arrangement, provision is made for the movement of the camshaft to be transmitted to a respective gas exchange valve via the hydraulic liquid. A control or switching valve, which is in the form of a solenoid valve in particular, is provided for control purposes. In the closed state, the camshaft is connected to the respective gas exchange valve via a so-called hydraulic linkage, and therefore the gas exchange valve necessarily follows a cam of the camshaft. By also partially opening the switching valve, the hydraulic fluid can pass into a compensation or pressure chamber, and therefore the gas exchange valve is decoupled from the movement of the cam. As a result, it is possible to vary the opening time point, the closing time point and the stroke of the gas exchange valve within an envelope curve which is predefined by the movement of the cam. This variation can be performed in a cylinder-selective manner.

Exact actuation of the gas exchange valves is of critical importance with regard to the high level of efficiency together with low emission of pollutants as is required in modern internal combustion engines. In hydraulic systems, the type of hydraulic liquid used, that is to say, in particular, the quality of the engine oil used, has a significant effect on operation. In particular, the effectiveness of the hydraulic control means is sensitive to fluctuations in the viscosity of the oil used. Such fluctuations occur for operational reasons due to different oil temperatures. As disclosed in the article “Elektrohydraulische Ventilsteuerung mit dem “MultiAir”-Verfahren [Electrohydraulic valve control using the “MultiAir” method],” the temperature-dependent fluctuations in oil viscosity have to date been taken into consideration in a model-based control algorithm which takes into consideration the measurement values from an oil temperature sensor.

This temperature-dependent and therefore indirect determination operation has disadvantages and does not take into consideration, for example, aging of the engine oil or wear of the hydraulic components.

Proceeding from this, the invention is based on the problem of specifying an improved method and an improved control device for directly determining a characteristic viscosity variable for an engine oil, it being possible, in particular, to take aging and wear effects into consideration too.

### SUMMARY OF THE INVENTION

According to the invention, the problem is solved by a method and a control device for determining a characteristic viscosity variable of an engine oil in an internal combustion engine with hydraulic control of the gas exchange valves, in particular with electrohydraulic control of the gas exchange valves, as disclosed, for example, in the article “Elektrohydraulische Ventilsteuerung mit dem “MultiAir”-Verfahren [Electrohydraulic valve control using the “MultiAir” method]” in the German automotive engineering journal MTZ 12/2009. In the method, provision is made for a comparison variable, which is correlated with a measured oxygen concentration in an exhaust gas from the internal combustion engine, to be used as a measure of the characteristic viscosity variable, in particular as a measure of the viscosity itself. Therefore, in principle, a measure of the viscosity is derived or established from the measured oxygen concentration.

This refinement is based on the consideration that, particularly in the case of electrohydraulic actuation of the gas exchange valves, the oxygen concentration contained in the exhaust gas, with given operating parameters of the internal combustion engine, depends on the viscosity of the engine oil used. In the case of an electrohydraulic control system for actuating the gas exchange valves, deliberate actuation of a control or switching valve decouples the movement of the gas exchange valve from the movement of the camshaft. With the switching valve open, the hydraulic connection between the cam of the camshaft and the gas exchange valve, which connection is otherwise firm, is usually broken. The gas exchange valve usually moves to its starting state, the closed state, in a spring-operated manner. This automatic closing operation of the gas exchange valve, which closing operation is decoupled from the movement of the cam, is also called the ballistic phase in the text which follows since, in this region, the gas exchange valve is no longer forcibly guided. During the ballistic phase, the spring force operates against a frictional force which is definitively established by the viscosity of the engine oil. This means that the profile of the ballistic phase and therefore the time until the gas exchange valve is closed depends on the viscosity of the engine oil. At the same time, the closing time point also establishes the quantity of air drawn in for the respective combustion process. If, for example, the oil has a very high viscosity, the closing process of the gas exchange valve slows down and the closing time point shifts backward, and therefore a greater quantity of air is drawn into the cylinder overall in comparison to an engine oil with a lower viscosity. This is evidenced since the quantity of injected fuel (petrol/diesel) is predefined by an injection control arrangement in different oxygen concentrations in the exhaust gas.

On account of these relationships, the oxygen concentration contained in the exhaust gas is therefore at least an indirect measure of the current viscosity of the engine oil. Therefore, with the described method, the profile of the ballistic phase is, in principle, evaluated particularly in correlation with an envelope curve which is predefined by the movement of the cam.

The oxygen concentration is used for so-called λ adjustment in motor vehicles in order to set the ratio of fuel to oxygen in a desired manner. A stoichiometric ratio is set for the value λ=1, the engine is operated with an excess quantity of fuel (rich mix) when λ<1, and the internal combustion engine is operated with an excess quantity of air (lean mix) when λ>1. A so-called λ probe is used for λ adjustment, said λ probe determining the residual oxygen content in the exhaust gas, in particular by comparison with the oxygen content in the ambient air. The present method therefore uses pre-existing installations and information in the case of a motor vehicle. Therefore, no additional components are required to establish the characteristic viscosity variable of the engine oil. The viscosity is therefore determined, proceeding from an existing λ adjustment operation, solely in terms of control and therefore in a software-based manner.

The comparison variable which is used as a measure of the characteristic viscosity variable is, in one variant, preferably the measured oxygen concentration itself. As an alternative to this, the comparison variable is a variable which is derived from said measured oxygen concentration or the profile of a variable which is derived from said measured oxygen concentration, for example a control signal which is output by the λ adjustment means and is monitored for characteristic changes.

The characteristic viscosity variable is preferably the viscosity itself. However, as an alternative, it is also possible to use the comparison variable as an indirect measure of the viscosity variable for further evaluation operations.

According to an expedient development, the λ adjustment is evaluated in order to determine the characteristic viscosity variable. Therefore, in the case of this concept, the absolute value of the oxygen concentration is not evaluated, but rather the control behavior of the λ adjustment means. This is based on the consideration that, for example as a result of aging phenomena, the viscosity of the engine oil rises and that—in comparison to the preceding state—a faulty setting is made by means of the λ adjustment means and the oxygen content measured in the exhaust gas deviates from the oxygen content expected—if the oil property remains unchanged. This “fault” is corrected by the λ adjustment means. This correction, which is ultimately a correction of the oxygen concentration in the exhaust gas, is preferably used to determine the characteristic viscosity variable. The λ adjustment is therefore monitored, in particular, for typical deviations which can be induced by changes in the viscosity of the engine oil.

According to an expedient development, a correlation between the comparison variable and the characteristic viscosity variable is stored in a control device, for example as part of a family of characteristic curves. In this case, the correlation was determined, in particular, in advance in series of tests and experiments, so that only comparison of the detected comparison variable with the stored values is required to establish the characteristic viscosity variable during operation.

On account of the extremely wide variety of conditions under which the internal combustion engine can be operated, this correlation is, or the families of characteristic curves are, stored as a function of at least one operating parameter of the internal combustion engine, preferably as a function of a large number of operating parameters. Such operating parameters of the internal combustion engine are, in particular, the temperature of said internal combustion engine (and therefore the temperature of the engine oil), the speed of said internal combustion engine, the injection quantity selected on the basis of the current load requirement etc.

Provision is also preferably made for the correlation to be preferably additionally stored as a function of a characteristic variable of the engine oil. Such a characteristic variable is, in particular, the viscosity class, for example according to the SAE classification. This classification characterizes the warm-running properties at comparatively high ambient temperatures (summer oil) and the cold-running properties at comparatively cold ambient temperatures (winter oil). Therefore, families of characteristic curves are preferably stored for different engine oil classifications, again as a function of the operating parameters of the internal combustion engine.

Furthermore, provision is made, in a preferred development, for engine oils which are individualized according to manufacturer or brand to be stored in the families of characteristic curves. In this case, the families of characteristic curves represent, for example, the dependence of the residual oxygen concentration in the exhaust gas in relation to a control signal from the λ adjustment means or else directly in relation to the viscosity for predefined operating parameters and characteristic variables of the engine oil.

In a preferred development, the characteristic viscosity variable is determined in a cylinder-specific manner. This means that the comparison variable is determined for each cylinder of the internal combustion engine or at least for groups of cylinders of the internal combustion engine, and the characteristic viscosity variable is derived from said comparison variable. This is used, in particular, in motor vehicles of the kind which provide cylinder-specific λ adjustment or oxygen measurement. Therefore, the evaluation and analysis of the oxygen content in the exhaust gas and therefore the determination of the characteristic viscosity variable is more robust and more accurate and less susceptible to faults.

In preferred refinements, the determined characteristic viscosity variable is, as an alternative or in combination, used for a variety of derived measures and evaluation operations. In addition to evaluating the currently determined characteristic viscosity variable, the evaluation of the change in the characteristic viscosity variable can also be used in this case.

According to a preferred first alternative, a measure of the oil quality used is determined, as is, in particular, the SAE classification met by the engine oil. A profile of the comparison variable, for example as a function of the temperature etc., can be determined from the various measurement points by measuring or determining the comparison variable at various operating points of the internal combustion engine, that is to say at specific temperatures, rotation speeds etc. The kind of engine oil being used can be established from this profile by comparison with a stored family of characteristic curves. In the same way, engine oil which has been impermissibly used is also identified in a preferred refinement. Therefore, damage to the engine can be prevented by outputting a corresponding warning signal.

According to a preferred further evaluation, provision is made for the characteristic viscosity variable to be monitored for an abrupt change in order to identify, for example, that the engine oil has been changed. In this case, the control device preferably sets an identifier or marker which designates and identifies the change in engine oil. This identifier is preferably also used to establish the oil change interval. In a further preferred refinement, the characteristic viscosity variable is used, in principle, to establish the oil change interval. Specifically, deterioration in the engine oil is identified in good time on account of the continuous measurement. A deterioration of this kind compared to an originally calculated oil change interval can occur, for example, in the case of short journeys.

Finally, in a particularly expedient refinement, the valve control is influenced on the basis of the determined characteristic viscosity variable. Firstly, for example when aging of the engine oil is detected, that is to say when an increase in the viscosity is detected, the time points for actuating the switching valve are varied and matched to the new conditions. As a result, gas valve control which is as exact as possible is ensured in accordance with the respective requirements. Therefore, this measure has the result that the ballistic phase is terminated at the desired time point and the gas exchange valve is back in its closed position. The entire electrohydraulic control operation is preferably performed on the basis of the determined characteristic variable for the viscosity and not, as was previously customary, using the current oil temperature. Therefore, the entire control operation of the gas exchange valves is based on the actual state of the oil.

Furthermore, provision is made in a preferred refinement for a warning signal to be output when the determined oil viscosity does not permit disturbance-free operation of the engine. Therefore, even starting of the engine can be suppressed, for example in the case of extremely low external temperatures and an excessively high viscosity and an associated lack of lubrication of the engine. Specifically, a minimum external temperature which must not be undershot can be established on the basis of the oil state determined in a preceding operating cycle.

The characteristic viscosity variable is preferably determined continuously or at intervals during operation of the internal combustion engine and therefore more or less continuously. In this case, provision may be made for the characteristic viscosity variable to be determined only once or a few times during one operating cycle of the internal combustion engine (that is to say between starting and stopping of the engine).

### BRIEF DESCRIPTION OF THE DRAWINGS

An exemplary embodiment of the invention will be explained in greater detail below with reference to the figures, in which:

FIG. 1 shows, in a schematic and highly simplified illustration of a detail, the basic manner of operation of an electrohydraulic control means of a gas exchange valve in a motor vehicle engine,

FIG. 2 shows, in a simplified illustration, the typical profile of a control signal for a switching valve of the electrohydraulic control means and the profile, which is produced by it, of the gas exchange valve with a ballistic phase in comparison to the profile which the gas exchange valve would assume if forcibly coupled to the cam of the camshaft, and

FIG. 3 shows an exemplary profile of a lambda correction value as a function of a phase angle Φ which is a measure of the phase relationship between the closed position of the gas exchange valve and a rotation position of the crankshaft.

Identically acting parts are provided with the same reference symbols in the figures.

### DETAILED DESCRIPTION OF THE INVENTION

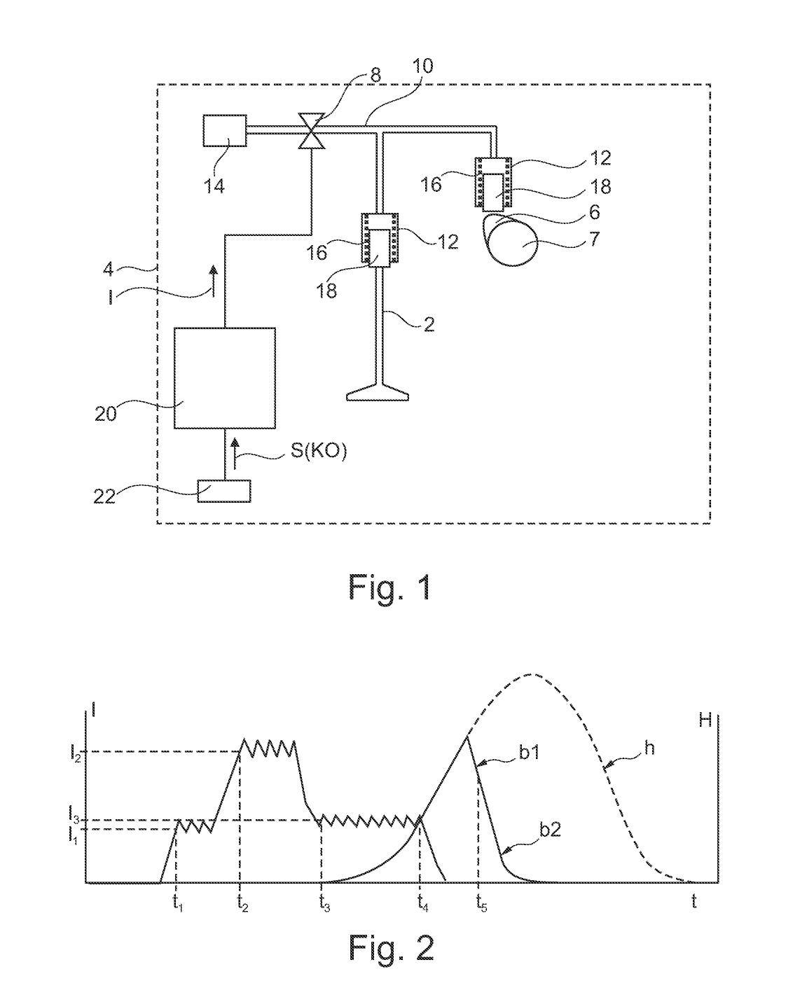

An electrohydraulic control system for hydraulically controlling a gas exchange valve 2 in a motor vehicle 4 which is indicated by a dashed border in FIG. 1 comprises a hydraulic system which transmits a movement of a cam 6 of a camshaft 7 to a respective gas exchange valve 2 by means of a hydraulic liquid, specifically the engine oil. The electrohydraulic valve control means is known per se. An essential feature is a switching valve which, in particular, is in the form of a solenoid valve 8 and is connected in a hydraulic line 10. The hydraulic line 10 is connected firstly to the cam 6 and secondly to the gas exchange valve 2 via a hydraulic cylinder 12. The hydraulic line 10 to a compensation or pressure chamber 14 can be blocked by means of the solenoid valve 8. Pistons 18 are mounted within the hydraulic cylinder 12, for example such that they can be moved against the force of a spring 16. In the event of rotation of the cam 6, the piston 18 of the associated hydraulic cylinder 12 follows the movement of the cam. When the solenoid valve 8 is closed, the hydraulic system acts in the manner of a hydraulic linkage, and therefore the piston 18 in the hydraulic cylinder 12 which is associated with the gas exchange valve 2 directly follows the movement of the cam 6.

The oil can pass into the pressure chamber 14 by opening of the solenoid valve 8, and therefore the movement of the gas exchange valve 2 is decoupled from the movement of the cam 6.

The solenoid valve 8 is connected to a control or evaluation unit 20. The control unit 20 is integrated, for example, in the engine control means. The solenoid valve 8 is supplied with a control signal by means of the control unit 20. In the exemplary embodiment, this control signal is a field current I for a magnet coil of the solenoid valve 8.

The control unit 20 is also connected to a so-called λ probe 22. The λ probe 22 is arranged in an exhaust gas line (not illustrated in any detail here), usually in an exhaust gas manifold, and measures the (residual) oxygen content KO in the exhaust gas from the internal combustion engine of the motor vehicle 4 in a manner which is known per se. The λ probe 22 outputs a corresponding oxygen measurement signal S(KO) to the control unit 20 and is used there for so-called λ adjustment. The combustion parameters such as injection quantity, opening and closing time points of the gas exchange valves 2, possibly ignition time points etc., are adjusted by means of the λ adjustment means in a manner which is known per se as a function of the current (load) requirements. In this case, the adjustment variable is the measured oxygen content KO.

The solenoid valve 8 is usually open in the inactivated state, and therefore the hydraulic line 10 is free in the direction of the pressure chamber 14. In the activated state, that is to say when the solenoid valve 8 is supplied with an adequate field current I, the solenoid valve 8 is in its closed position. In this case, the solenoid valve 8 has a typical design which is known per se. An armature is operated by the magnet, which is formed by an electrical coil, in the closing and opening directions. A closure element for closing the hydraulic line 10 is arranged on this armature. The magnetic force usually acts against a spring force of a spring which is mounted in the solenoid valve 8 and pushes the solenoid valve 8 into its starting position, in particular its open position, in the inactive state.

The field current I exhibits a typical profile, as illustrated in FIG. 2. The coil is usually initially supplied with a switch-on current I₁ which is established at a time t₁. This switch-on current I₁ leads only to pre-magnetization, but not to a movement of the closure element. For the purpose of activating, that is to say closing, the valve 8, said valve is supplied with a closing current I₂ which is established at time point t₂. At this time point, the closure element moves to its closed position. After the closing operation, the current is, at a time t₃, usually reduced to a holding current I₃ which is greater than the switch-on current I₁. At a time point t₄, the current supply is switched off and the field current I disappears. The time point t₄ is predefined by the control unit 20 as a function of the current requirements.

In addition to the field current I, the profile of the stroke H of the gas exchange valve 2, which profile is associated with said field current, is also plotted against time in FIG. 2. The dashed line represents an envelope curve h which represents the stroke movement of the gas exchange valve 2 with the solenoid valve permanently closed. The envelope curve h therefore corresponds to the movement of the gas exchange valve 2 when said gas exchange valve necessarily directly follows the movement of the cam 6.

The stroke movement of the gas exchange valve 2 deviates from the envelope curve h by the field current I being switched off at time point t₄. The gas exchange valve 2 closes at an earlier time point. The actual profile of the stroke movement of the gas exchange valve 2 in the case of the profile of the field current I which is illustrated in FIG. 2 is represented by the solid line. As can be seen, the profile of the stroke movement deviates from the envelope curve h after an initial phase which is identical to the envelope curve h. The falling movement, that is to say the closing operation of the gas exchange valve 2, is called the ballistic phase in the present case since, in this state, the gas exchange valve 2 is returned to the closed position solely on account of the spring force. In this case, the spring force operates against the system-induced frictional forces. These are definitively also produced by the engine oil and the viscosity η of said engine oil. The ballistic phase can be divided into two subregions b1, b2 in this case. The first sub-phase b1 is produced by a (ballistic) closing movement of the solenoid valve 8 for which the same considerations apply as for the gas exchange valve 2. The valve is adjusted in a spring force-operated manner against the frictional force, which is definitively produced by the viscosity, in this case too. The second ballistic sub-phase b2 is then produced solely by the gas exchange valve 2. The solenoid valve 8 is in its closed position at time point t₅.

The area under the curve for the stroke movement of the gas exchange valve 2 is correlated with the quantity of air drawn in for a combustion stroke and therefore determines, given a defined injection quantity of the injected fuel, the mixing ratio between fuel and air. Therefore, the oxygen content KO in the exhaust gas is also influenced at the same time.

Experiments have now shown that the profile of the ballistic phase b1, b2 is dependent on the viscosity η of the engine oil used. At a relatively high viscosity, the ballistic phase b1, b2 shifts to the right, that is to say the gas exchange valve 2 closes more slowly. The reason for this can be found in the higher frictional force created by the higher viscosity.

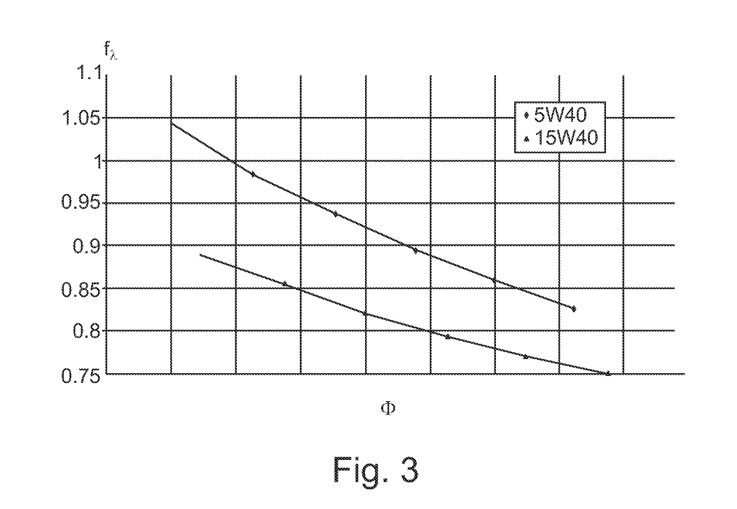

In this respect, FIG. 3 shows, by way of example, the result of a series of tests in which the closing time points t₄ of the solenoid valve 8 have been varied for two different engine oils, specifically one with the SAE classification 5W40 and one with the SAE classification 15W40. The closing time points t₄ were varied in steps of 2.5° of the phase angle Φ in this case. The phase angle Φ is an electrical control variable which determines the switch-off of the supply of power to the solenoid valve 8 and consequently the closing time point of the gas exchange valve 2. It is therefore a measure of the phase relationship between the closed position of the gas exchange valve and a rotation position of the crankshaft. As the Φ value increases, the gas exchange valve 8 is opened for a longer period of time and more oxygen enters the combustion space.

A correction factor f_{λ} which shows a deviation (ratio) of the actual λ value in relation to the setpoint λ value is plotted on the y axis. When f_{λ}=1, the actual λ value corresponds to the setpoint λ value. In general, combustion is too lean when the λ value is too high and combustion is too rich when the λ value is too low. The λ value is measured by means of the λ probe in a manner which is known per se and is a measure of the residual oxygen concentration KO in the exhaust gas. A desired λ value is set using the usual λ adjustment means as a function of the current operating requirements. In this case, the adjustment parameter is usually the injected quantity of fuel.

In the experiments, the phase angle Φ was successively varied at different predefined engine parameter values and different oil quantities. The critical parameters in this case were the speed of the engine, the position of the accelerator pedal and the engine oil temperature.

As also disclosed in FIG. 3 in particular, the oil quality and therefore the oil viscosity η exhibited a significant influence on the correction factor f_{λ}.

The experiments showed that the correction factor f_{λ} varies as a function of the oil used, that is to say the deviation from the setpoint λ value is oil-dependent. The measured residual oxygen content KO therefore deviates from the setpoint oxygen content in the manner in which it is intended to be set by means of the λ adjustment means. In general, the deviation from the setpoint λ value increases as the deviation of the actual viscosity from a stored nominal viscosity curve increases. A decreasing correction factor f_{λ} means an increase in the λ value in the lean direction, and vice versa.

Proceeding from this basic information, provision is therefore made to integrate an analysis unit in the control device 20, said analysis unit drawing conclusions about the current viscosity η of the engine oil used on the basis of the oxygen concentration KO measured by means of the λ sensor during operation. In this case, the measured oxygen concentration KO is selectively directly evaluated or else the control signal from the λ adjustment means is evaluated and analyzed. As shown specifically by FIG. 3, a need for correction results as soon as the actual viscosity deviates from a (for example temperature-dependent) setpoint viscosity which is stored in the control unit 20. This deviation in viscosity therefore leads to changed adjustment behavior of the λ adjustment means, and this behavior can be evaluated.

To this end, a large number of families of characteristic curves are preferably stored for various sets of parameters. Such families of characteristic curves indicate, for example, similarly to what is illustrated in FIG. 3, a correlation between the correction factor f_{λ} and the electrical phase angle Φ for different engine oil variants, in each case at a defined operating point of the engine. The operating point of the engine is understood to mean that the parameters which characterize the combustion process, for example engine speed, accelerator pedal position, oil temperature etc., have a fixed defined value.

During the analysis, conclusions are then preferably drawn about the viscosity and quality of the oil used by simply comparing the measured values with the stored families of characteristic curves. This information is then preferably used selectively or in combination to:
determine a measure of the oil quality used, in particular determine the SAE classification to which the engine oil used is to be assigned,
identify impermissible engine oils,
identify an abrupt change in the engine oil, for example after the engine oil is changed, and set a marker, in particular in the control unit 20,
establish and possibly indicate the time for an oil change on the basis of the set marker or else on the basis of the currently determined oil quality,
monitor the engine oil used for changes in terms of its properties (aging),
take into consideration the obtained information about the engine oil used and its effects on the ballistic phase directly in order to control the gas exchange valves 2, in particular for λ adjustment, and to use it to define, for example, the closing time point t₄ of the solenoid valve 8, and also
perform the entire gas exchange valve 2 control operation as a function of the determined oil quality or as a function of the determined viscosity properties of the oil.

In comparison to the previous control operation, as a function of the currently measured oil temperature, the last-mentioned point has the critical advantage that the currently actual properties of the engine oil are used for the control operation, and therefore aging effects, for example, are automatically taken into consideration.

A particular advantage of this method is the fact that additional hardware components besides the components already present in the motor vehicle, for example the λ probe, are not required and not provided either. Evaluation and analysis are performed solely using measurement data which is available in any case.

### LIST OF REFERENCE NUMERALS

2 Gas Exchange Valve
4 Motor Vehicle
6 Cam
7 Camshaft
8 Solenoid Valve
10 Hydraulic Line
12 Hydraulic Cylinder
   14 Pressure Chamber
16 Spring
18 Piston
20 Control Unit
22 λ probe
b1, b2 Ballistic Phases
η Viscosity
h Envelope Curve
f_{λ} Correction Factor
KO Oxygen Content
S(KO) Oxygen Measurement Signal
I Field Current

1-9. (canceled)

10. A method for determining a characteristic viscosity variable of engine oil in an internal combustion engine with hydraulic control of the gas exchange valves, the method comprising the steps of:
measuring oxygen concentration in an exhaust gas from the internal combustion engine;
correlating a comparison variable with the oxygen concentration measured in the exhaust gas; and
using the comparison variable as a measure of the characteristic viscosity variable.

11. The method according to claim 10, wherein the comparison variable is used as a measure of viscosity of the engine oil.

12. The method according to claim 10, wherein the measured oxygen concentration is used for λ adjustment and the λ adjustment is evaluated to determine the characteristic viscosity variable.

13. The method according to claim 12, wherein a correction of the oxygen concentration, which is performed by the λ adjustment, is evaluated to determine the characteristic viscosity variable.

14. The method according to claim 10, wherein a correlation between the comparison variable and the characteristic viscosity variable is stored in a control device.

15. The method according to claim 14, wherein the correlation is stored as a function of at least one operating parameter of the internal combustion engine.

16. The method according to claim 15, wherein the operating parameter is temperature or engine speed.

17. The method according to claim 14, wherein the correlation is stored as a function of a characteristic variable of the engine oil.

18. The method according to claim 14, wherein the correlation is stored as a function of a viscosity class of the engine oil.

19. The method according to claim 10, wherein the internal combustion engine has a plurality of cylinders and the characteristic viscosity variable is determined in a cylinder-specific manner.

20. The method according to claim 10, wherein the determined characteristic viscosity variable is evaluated and used selectively or in combination for:
determining a measure of an oil quality:
identifying impermissible engine oils;
identifying and evaluating an abrupt change in the characteristic viscosity variable;
establishing an oil change interval; and
controlling the gas exchange valves.

21. A control device for determining a characteristic viscosity variable of an engine oil in an internal combustion engine having gas exchange valves, with the gas exchange valves being hydraulically controlled, and with the control device being formed in such a way that a comparison variable, which is correlated with a measured oxygen concentration in an exhaust gas from the internal combustion engine, is used as a measure of the characteristic viscosity variable of the hydraulic liquid.

22. The control device according to claim 21, wherein the comparison variable is used as a measure of viscosity of the hydraulic liquid.
